(19) United States
(12) Patent Application Publication
(10) Pub. No.: US 2004/0102169 A1
(43) Pub. Date: May 27, 2004

(54) Real-time active phase control for high power amplifier combining for space applications

(76) Inventors: Bhaskar Durvasula, Los Altos, CA (US); Rolf K. Klibo, Palo Alto, CA (US); Gerald T. Murdock, Sunnyvale, CA (US); James D. Sawdey, Dublin, CA (US); James J. Sowers, Sunnyvale, CA (US)

Correspondence Address: J. E. Kosinski, Loral Space & Communications, Ltd., Suite 303, 655 Deep Valley Drive, Rolling Hills Estates, CA, 90274, US

(21) Appl. No.: 10/304,612

(22) Filed: Nov. 25, 2002

(51) Int. Cl. H04B 1/00; H04B 7/00

(52) U.S. Cl. 455/260; 455/69; 455/126; 455/304

(57) ABSTRACT

A system is provided that enables real time active phase control at higher RF signal power levels to be achieved by compensation for phase variations due to daily and lifetime fluctuation of equipment temperature, equipment aging effects and path length changes due to redundancy reconfiguration among others. This automated approach achieves the fastest and most accurate phase correction for efficient signal recombining. The system employs an RF signal which is split into parallel paths whose phase is adjusted employing the output of a feedback device and then amplified and sensed to provide the feedback signal and ultimately recombined.

### I. FIELD OF THE INVENTION

This invention relates generally to radio frequency (RF) system electronics and more to real time active phase control systems employed therein.

### II. PRIOR ART

It is known in the prior art to employ parallel amplifiers with combining phase control as in U.S. Pat. No. 5,222,246 issued Jun. 22, 1993 to Wolkstein entitled “Parallel Amplifiers with Combining Phase Controlled from Combiner Difference Port.” Therein there is disclosed a power amplifier arrangement which includes a power divider for dividing the signal to be amplified into equal-amplitude components. Each component is amplified by a signal amplifying path and the amplified signals are applied to a phase-sensitive power combiner. The combined signal appears at the sum port and a phase-related difference signal appears at a difference port of the combiner. The difference signal is processed to produce a control signal for controlling the relative phases of the signals passing through the signal amplifying paths. This patent is directed to a real-time feed back loop identifying a solution for splitting a signal into two paths and amplifying and then detection of phase mismatch at the output of a difference port on a combining device. Thus there is provided a solution for splitting a signal into two paths and amplifying and then detection of phase mismatch at the output of a difference port on a combining hybrid device. Provision for multiple channels is provided for by combining more balanced amplifiers through exclusive use of hybrids and therefore suffering the loss of the additional combining. It also is constrained by power handling capability of a single device and does not provide for independent phase control of parallel path components.

In U.S. Pat. No. 6,456,165 issued Sep. 24, 2002 to Kelkar entitled “Phase Error Control for Phase-Locked Loops”, there is disclosed a phase-locked loop (PLL) device which includes a phase error control for allowing quick transitions from a first operating point to a second operating point when the phase error exceeds a user-defined threshold. Phase error control is accomplished by adding an additional charge pump and accompanying user-settable circuitry to the PLL device. This device, as well as several other phase-lock loops, is employed to apply phase detection and control to circuits with oscillators in order to lock to a frequency. Thus this system is not seen to provide the novel features of the real time active phase control system of the instant invention.

In U.S. Pat. No. 6,445,249 issued Sep. 3, 2002 to Khan et al entitled “Modification of Phase Component of Error Signal to Reduce Variation of Phase Component of Output Signal of Power Amplifier” there is disclosed a system (100) is coupled with power amplifier (106) wherein a generation component (166) generates error signal (110) based at least in part on an input signal (144) for the system (100). The error signal (110) includes a phase component and the input signal (144) includes an envelope component. A modification component (130) modifies the phase component of the error signal (110) in response to the envelope component of the input signal to reduce variation of a phase component of the power amplifier output signal (194). This system, however, does not provide for parallel amplification paths with subsequent combining.

### III. OBJECTS OF THE INVENTION

It is therefore an object of this invention to provide a novel real time active phase control system devoid of the above recited deficiencies.

It is a further object of this invention to provide a real time active phase control for high power amplifier (HPA) in combining signals for space applications.

Yet another object of this invention is to provide a system which will achieve high RF signal power levels through efficient control of multiple parallel amplification paths.

Yet again another object of this invention is to provide a system wherein the RF signal is split into parallel paths that are each amplified in similar high power amplifiers.

Still another object of this invention is to provide a real time active phase control device or system operating at higher RF signals power levels to be achieved by compensating for phase variations due to daily and lifetime fluctuations of the system.

Yet again another object of this invention is to provide a real time automated system which achieves the fastest and most accurate phase correction for efficient signal recombining.

Another object of this invention is to provide a real time automated system which allows multiple channels with independent outputs to be combined thereby reducing the loss of the combining structures.

### IV. SUMMARY OF THE INVENTION

These and other objects of the instant invention are accomplished generally speaking by providing a system which employs an RF signal that is split into parallel paths whose phase is adjusted, amplified and then combined. More specifically, an RF signal is employed which is split into parallel paths. The phase of said split signal is adjusted employing the output of a feedback device. The adjusted signal is then amplified and sensed to provide the feedback signal and ultimately combined.

### V. BRIEF DESCRIPTION OF THE DRAWINGS

The inventive structural component of the instant invention may be more fully understood with reference to the accompanying drawings of which:

FIG. 1 is a generalized payload with combined high power amplifiers.

FIG. 2 illustrates a simplified real time active phase control system.

FIG. 3 illustrates a signal splitter and phase control system.

FIG. 4 depicts a phased monitoring and feedback generation system.

### VI. DETAILED DESCRIPTION OF THE DRAWINGS

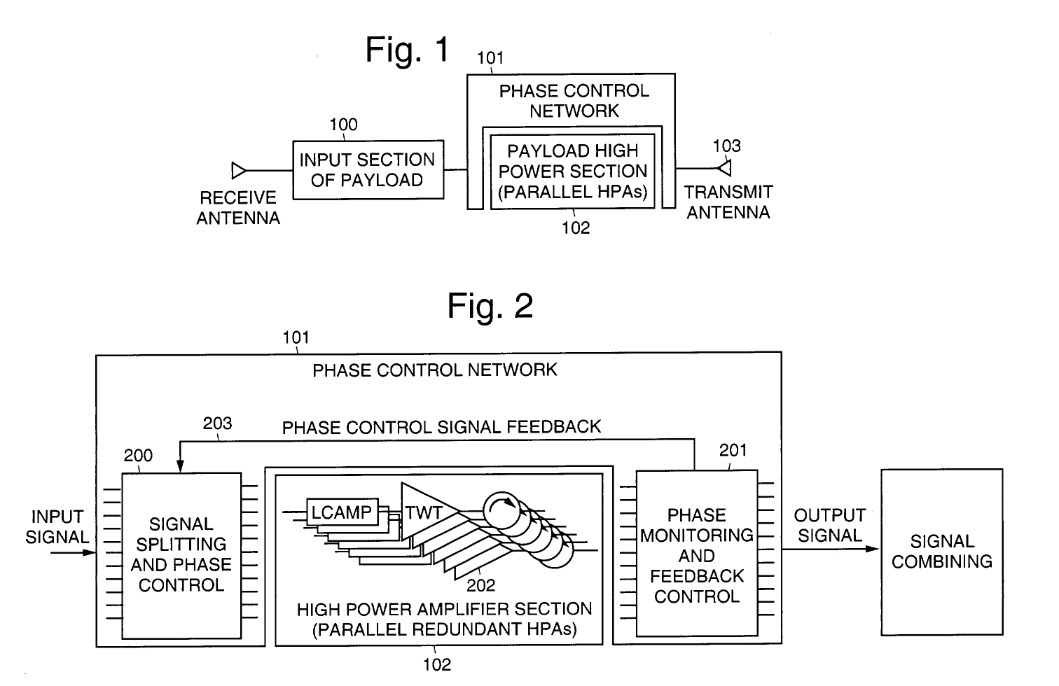

In FIG. 1 there is seen a phase monitoring and control network to provide sensing of multiple RF amplification paths to allow coherent combining to result in a single high powered signal. A signal is received at the input section (100) and then enters the phase control network (101) housing the high power amplifiers (102). This signal thus processed is transmitted from transmit antenna (103).

In FIG. 2 there is seen a phase control network having an input section (200) designated as signal splitting and phase control and an output section (201) designated as phase monitoring and feedback control. As seen in FIG. 2, the input section receives a low power signal which is split to provide parallel paths to the multiple high power amplifiers (202). Phase adjustment is performed on each of the low power level signals. In the output section (201) the amplified signals are monitored and a phase control signal (203) is generated and sent back to the phase adjustment devices (not shown). Thus in-phase high-power signals can be combined and transmitted from the system.

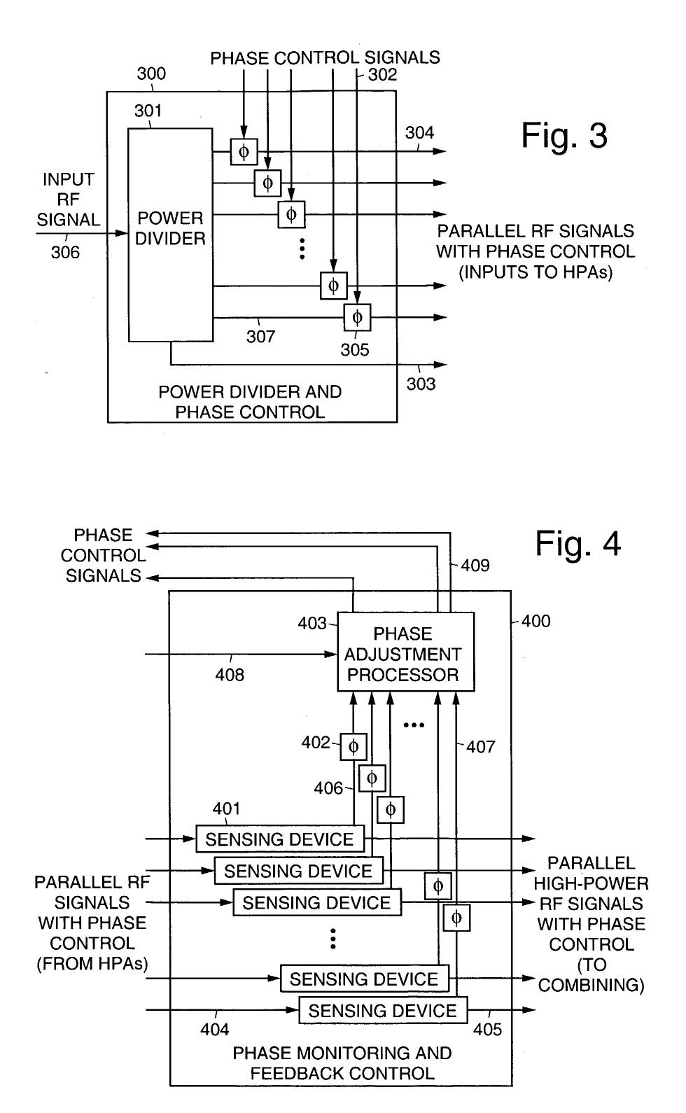

In FIG. 3 there is shown the main components of the input section having a power divider and phase control (300), a power divider (301), phase adjustment devices (305) phase control signals (302), a reference RF signal (303) and parallel RF signals (304).

The input signal (306) comes into the power divider (301) and is split into the required number of parallel signals (307). Each parallel signal (307) being approximately the same amplitude.

Each parallel signal (307) is then adjusted in phase in a phase adjustment device (305) under the control of a phase control signal (302). Each phase adjustment device (305) is controlled independent of the other phase control devices. This phase control can be either analog (continuous), or digital (discrete phase steps) or both, and are able to provide at least 360 degrees of phase adjustment. The parallel signals out of the phase adjustment devices (304) are output from the power divider and phase control (300) to the power amplifiers. Each parallel output signal has a phase unique and independent of the other signal paths (304).

In one option of this invention, the input signal (306) is split into one additional path to create a reference signal (303). The reference signal is described in the phase monitoring and feedback control (FIG. 4).

In FIG. 4 there is seen a phase monitoring and feedback control (400) of the instant invention, a sensing device (401), a static phase adjustment device (402) and a phase adjustment processor (403). The parallel amplified signals (404) from the power amplifiers are monitored to create a feedback signal (409) and are output as parallel, phase adjusted, amplified signals (405) to a combining network.

Each amplified signal (404) is sensed and a replica signal (406) is generated for processing to create a feedback (409) to the phase adjustment devices (305). The sensed high-power signals (405) are then output for combining.

A low power replica signal is created in the sensing process. The replica is typically created by using a directional coupler as the sensing device (401) and splitting off a small portion of energy (406), about 30 dB down (0.1%) from the amplified signal (404). A static phase adjustment device (402) is implemented in each coupled signal path to compensate for any phase variation of the paths from the output of each sensing device to the output of the combining process. This phase adjustment device is a static device that is set at integration, or is capable of being adjusted by command. The output of this static phase adjustment device, the phase adjusted rf replica (407), is the input to the phase adjustment processor (403).

This replica is operated upon to determine the need for a phase adjustment at the input section (200 or 300) of the network. The processing of this replica signal can take several different forms, including:

1. direct comparison with a reference signal (408 or 303) from the power splitter (301), or

2. direct comparison with another replica chosen to be the reference (not shown), or

3. summation of all phase adjusted replicas and search for peak summation energy based on phase adjustments variations at the phase adjustment device (305).

The output of the phase control processor (403) is a set of unique control signals (409 or 302) for each phase control device in FIG. 3.

Any suitable radio frequency signal may be processed by the system of the instant invention. Typical radio frequency signals include those in the range of 200 megahertz to 100 Gigahertz.

Any suitable splitting device may be used in operating the system of the instant invention. Typical signal splitting devices include directional couplers, power dividers and hybrids thereof.

The signal of the system of the instant invention may be adjusted using any suitable phase adjusting device. Typical phase adjusting devices include phase shifters, diode or transistor networks and the like.

The signal as provided in the system of the instant invention may be amplified using any suitable means. Typical amplifying devices include solid state amplifiers, Traveling Wave Tubes (TWT) and the like.

The phase of the signal may be sensed by employing any suitable sensing device. Typical sensing devices include directional coupler combined with power summers, coherent detection devices and the like.

The signal of the system of the instant invention may be combined using any suitable system. Typical combining signal mechanisms include multi-port antenna, power summers and the like.

While the present invention has been particularly described with respect to a preferred sequence of process steps in its method claims and/or certain elements in its preferred embodiment, it will be understood that the invention is not limited to these particular methods and/or apparatus described in the preferred embodiments, the process steps, the sequence, or the final structures depicted in the drawings. On the contrary, it is intended to cover all alternatives, modifications, and equivalents as may be included within the spirit and scope of the invention defined by the appended claims.

In particular, the scope of the invention is intended to include, for example, those devices wherein the amplitude of the signal is sensed in addition to its phases to provide optimal beam shaping characteristics among other improvements.

What is claimed is:

1) A real time active signal phase control system comprising:
a) a signal splitter which provides a signal split into parallel paths,
b) a phase adjuster which operates to adjust the phase of said split signal,
c) an amplifying device which amplifies said adjusted signal,
d) a sensing device which senses the phase of said signal, and feeds back said sensed phase in order to adjust the phase, and
e) a signal combiner to combine said sensed signals.

2) The system as provided in claim 1 wherein said signal which is processed is in a frequency range of 200 Megahertz to 100 Gigahertz.

3) The system as defined in claim 1 wherein said signal is divided into parallel paths by a signal splitter comprising a power divider.

4) The system as defined in claim 1 wherein the phase of said split signal is adjusted by a phase adjusting device comprising a phase shifter.

5) The system as defined in claim 1 wherein said adjusted signal is amplified by an amplifying device comprising at least one Traveling Wave Tube (TWT).

6) The system as defined in claim 1 wherein the phase of the signal is sensed by a device comprising a coherent detection device.

7) The system as defined in claim 1 wherein said signals are combined employing a device comprising a multipart antenna.

8) A method for providing real time active signal phase control comprising:
a) splitting said signal into parallel paths,
b) adjusting the phase of said split signal,
c) amplifying said adjusted signal,
d) sensing the phase of said signal and feeding back said sensed phase in order to adjust the phase, and
e) combining said sensed signals.

9) The method as defined in claim 8 wherein a signal having a radio frequency of 200 Megahertz to 100 Gigahertz is employed.

10) The method as defined in claim 8 wherein said signal is split into parallel paths employing a power divider.

11) The method as defined in claim 8 wherein said phase of said split signal is adjusted by a phase adjusting device comprising a phase shifter.

12) The method as defined in claim 8 wherein said adjusted signal is amplified by an amplifying device comprising at least one Traveling Wave Tube (TWT).

13) The method as defined in claim 8 wherein the phase of the signal is sensed by a device comprising a coherent detection device.

14) The method as defined in claim 8 wherein said signals are combined employing a device comprising a multipart antenna.
